(19) United States
(12) Patent Application Publication
(10) Pub. No.: US 2009/0282009 A1
(43) Pub. Date: Nov. 12, 2009

(54) SYSTEM, METHOD, AND PROGRAM PRODUCT FOR AUTOMATED GRADING

(75) Inventors: Marc Levey, Las Vegas, NV (US); Andre Lereu, Las Vegas, NV (US)

Correspondence Address: Andre Lereu, 3157 Espanol Dr., Las Vegas, NV, 89121, US

(73) Assignee: Tags Ltd, Las Vegas, NV (US)

(21) Appl. No.: 12/118,665

(22) Filed: May 9, 2008

(51) Int. Cl. G06F 7/06; G06K 9/18; G06F 17/30

(52) U.S. Cl. 707/4; 382/182; 707/E17.044; 707/E17.014

(57) ABSTRACT

A method for automated evaluation of documents includes steps of scanning a set of documents with Optical Character Recognition (OCR) software to produce an electronic format, converting the electronic format into a character set associated with an ID marker and sending the character set and ID marker to a server for the evaluation. An additional step provides for receiving from the server a results set wherein the results set includes the results of a comparison of at least a portion of the character set to at least a portion of a predefined character set using search coordinates where the search coordinates were in part determined by an identification of an identification field and predefined coordinates of the identification field in the predefined character set and character set coordinates of the identification field in the character set.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to software. More particularly, the invention relates to a software system providing a method for automated grading.

### BACKGROUND OF THE INVENTION

On average, teachers spend 10 to 15 hours a week grading homework and schoolwork for their classes. Some software solutions currently exist to assist teachers in grading. However, these solutions have weaknesses. One known solution requires that the teacher hand grade the homework or schoolwork, and then feed the graded papers into a machine which recognizes circles and checkmarks. This solution then tabulates the results and keeps track of the results. This particular solution also requires that the teacher uses a certain type of form and a specific size and shape of paper as well as having to feed the sheets into the machine all in the same direction. This solution does not reduce the grading time for the teacher since the system merely tabulates results and the teacher must still hand grade the work. Optical Character Recognition (OCR) is used to recognize students' answers. OCR by itself merely recognizes handwritten information and converts it to ASCII text and does not actually grade the work. Many known solutions use OCR to recognize the students' answers. However, these solution however only grades an answer sheet, and require a special hand held or portable unit with which to enter the answers for the various questions. Such solution also require several hardware components

In view of the foregoing, there is a need for improved techniques for providing an automated grading system that reduces the amount of time it takes for teachers to grade school work and homework and does not require special forms or equipment.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1a and 1b are flowchart illustrating an exemplary process for using an automated grading system, in accordance with an embodiment of the present invention;

FIGS. 2a and 2b illustrate an exemplary form as scanned using distortion correction, in accordance with an embodiment of the present invention. FIG. 2a illustrates the form with no distortion, and FIG. 2b illustrates the form with some distortion;

FIG. 3 illustrates an exemplary handwriting profile sheet, in accordance with an embodiment of the present invention;

FIG. 4 illustrates a portion of an exemplary worksheet that is graded using one verses one comparison and an exemplary corresponding score table, in accordance with an embodiment of the present invention;

FIG. 5 illustrates a portion of an exemplary worksheet that is graded using one verses many comparison and an exemplary corresponding score table, in accordance with an embodiment of the present invention;

FIG. 6 illustrates a portion of an exemplary worksheet that is graded using many verses many comparison and an exemplary corresponding score table, in accordance with an embodiment of the present invention;

FIG. 7 illustrates a portion of an exemplary essay that is graded using many verses many comparison and an exemplary corresponding score table, in accordance with an embodiment of the present invention; and

FIGS. 8 and 9 illustrate exemplary free form homework assignments that may be graded by preferred embodiments of the present invention. FIG. 8 is an exemplary worksheet on reading clocks, and FIG. 9 is an exemplary worksheet on multiplication as repeated addition.

FIG. 10 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method, and program product for automated grading is presented.

In one embodiment, a method for automated evaluation of documents is presented. The method includes steps of scanning a set of documents with Optical Character Recognition (OCR) software to produce an electronic format, converting the electronic format into a character set associated with an ID marker and storing the character set and ID marker in a first database. A step retrieves a predefined character set corresponding to the ID marker from a second database. Further steps provide for identifying an identification field and predefined coordinates of the identification field in the predefined character set, locating the identification field and character set coordinates of the identification field in the character set and generating search coordinates from the predefined coordinates and the character set coordinates. A step compares at least a portion of the character set to at least a portion of the predefined character set using the search coordinates. Additional steps provide for compiling a results set from results of the comparing, storing the results set in the second database and generating a notification that the step of comparing is complete and the results set can be queried. In another embodiment the step of comparing further includes comparing the portion of the character set to a plurality of portions of the predefined character set. In a further embodiment the step of comparing further includes comparing a plurality of portions of the character set to a plurality of portions of the predefined character set. Another embodiment further includes the step of storing a worksheet character set and ID marker from a publisher as the predefined character set and ID marker in the second database. Yet another embodiment further includes the steps of scanning a worksheet with OCR software to produce a worksheet electronic format, converting the worksheet electronic format into a worksheet character set associated with an ID marker and storing the worksheet character set and ID marker as the predefined character set in the second database. Still another embodiment further includes the step of grading results of the comparing. In yet another embodiment, the step of compiling the results further includes including the portion of the predefined character set. Other embodiments further include steps of querying the first database by a first user to generate a report, sending a portion of the report from the first user to a second user and notifying a user that a document is due to be completed. Yet another embodiment further includes the step of submitting a handwriting profile sheet and the step of converting further uses the handwriting profile sheet to improve accuracy.

In another embodiment a method for automated evaluation of documents is presented. The method includes steps for scanning a set of documents, steps for converting the scanning into a character set, steps for storing the character set, steps for retrieving a predefined character set, steps for identifying an identification field and predefined coordinates of the identification field in the predefined character set, steps for locating the identification field and character set coordinates of the identification field in the character set, steps for generating search coordinates from the predefined coordinates and the character set coordinates, steps for comparing at least a portion of the character set to at least a portion of the predefined character set using the search coordinates, steps for compiling a results set from results of the comparing, steps for storing the results set and steps for generating a notification that the step of comparing is complete and the results set can be queried. Other embodiment further include steps for storing the predefined character set, grading results of the comparing, querying the results set and submitting a handwriting profile sheet to improve accuracy.

In another embodiment, a method for automated evaluation of documents is presented. The method includes steps of scanning a set of documents with Optical Character Recognition (OCR) software to produce an electronic format, converting the electronic format into a character set associated with an ID marker and sending the character set and ID marker to a server for the evaluation. An additional step provides for receiving from the server a results set wherein the results set includes the results of a comparison of at least a portion of the character set to at least a portion of a predefined character set using search coordinates where the search coordinates were in part determined by an identification of an identification field and predefined coordinates of the identification field in the predefined character set and character set coordinates of the identification field in the character set. In another embodiment the step of receiving further includes receiving in the results set a comparison of the portion of the character set to a plurality of portions of the predefined character set. In yet another embodiment the step of receiving further includes receiving in the results set a comparison of a plurality of portions of the character set to a plurality of portions of the predefined character set. Another embodiment further includes the steps of scanning a worksheet with OCR software to produce a worksheet electronic format, converting the worksheet electronic format into a worksheet character set associated with an ID marker and sending the worksheet character set and ID marker to the server as the predefined character set. In yet other embodiment, the step of receiving further includes receiving the results of a grading of the comparison and the step of receiving further includes receiving the portion of the predefined character set in the results set. Other embodiments further include the step of querying the server by a first user to generate a report and the step of instructing the server to send a portion of the report to a second user. In still another embodiment, the step of converting uses a handwriting profile sheet to improve accuracy.

In another embodiment a method for automated evaluation of documents is presented. The method includes steps for scanning a set of documents, steps for converting the electronic format into a character set, steps for sending the character set to a server for the evaluation and steps for receiving from the server a results set. Other embodiment further include steps for sending a worksheet character set to the server as the predefined character set and steps for querying the server.

In another embodiment a computer program product for automated evaluation of documents is presented. The computer program product includes computer code that scans a set of documents with Optical Character Recognition (OCR) software to produce an electronic format, converts the electronic format into a character set associated with an ID marker and stores the character set and ID marker in a first database. Computer code retrieves a predefined character set corresponding to the ID marker from a second database. Computer code identifies an identification field and predefined coordinates of the identification field in the predefined character set, locates the identification field and character set coordinates of the identification field in the character set and generates search coordinates from the predefined coordinates and the character set coordinates. Additional computer code compares at least a portion of the character set to at least a portion of the predefined character set using the search coordinates, compiles a results set from results of the comparing, stores the results set in the second database and generates a notification that the step of comparing is complete and the results set can be queried. A computer-readable medium stores the computer code. Another embodiment further includes computer code that compares the portion of the character set to a plurality of portions of the predefined character set. Still another embodiment further includes computer code that compares a plurality of portions of the character set to a plurality of portions of the predefined character set. Yet another embodiment further includes computer code that scans a worksheet with OCR software to produce a worksheet electronic format, converts the worksheet electronic format into a worksheet character set associated with an ID marker and stores the worksheet character set and ID marker as the predefined character set in the second database. Yet other embodiment further include computer code that grades results of the comparing and when compiling the results further includes the portion of the predefined character set. Still other embodiments further include computer code that allows querying the first database by a first user to generate a report and computer code that uses a handwriting profile sheet to improve accuracy when converting the electronic format.

In another embodiment a system for automated evaluation of documents is presented. The system includes means for scanning a set of documents, means for converting the scanning into a character set, means for storing the character set, means for retrieving a predefined character set, means for identifying an identification field and predefined coordinates of the identification field in the predefined character set, means for locating the identification field and character set coordinates of the identification field in the character set, means for generating search coordinates from the predefined coordinates and the character set coordinates, means for comparing at least a portion of the character set to at least a portion of the predefined character set using the search coordinates, means for compiling a results set from results of the comparing, means for storing the results set and means for generating a notification that the comparing is complete and the results set can be queried. Various other embodiments further include means for storing the predefined character, means for grading results of the comparing, means for querying the results set, means for notifying a user that a document is due to be completed and means for submitting a handwriting profile sheet to improve accuracy.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide automated software systems for grading the work of students. Preferred embodiments combine the technology of Optical Character Recognition (OCR) with that of data matching software to recognize and grade data scanned into the systems. Preferred embodiments also enable users to upload information to the system through the Internet.

By combining OCR with data matching software in preferred embodiments of the present invention, teachers are able to scan in their students' homework or class work and upload the work to servers through the Internet. The OCR software scans the work for handwritten information and converts the information into ASCII text. That ASCII text is then compared to a predetermined set of data with the data matching software, which is considered an answer key. In preferred embodiments, the system's servers recognize the correct answers to the students' work, because the work may be either pre-loaded worksheets with answers already entered into the system or the teacher may scan in an answer sheet that the system uses to create an answer template. In preferred embodiments, once the work is graded, the software sends an e-mail to the teacher, notifying the teacher that grading is complete. The teacher then has the option to review every answer that was marked as incorrect, so that if the software has made a mistake, the teacher can override the software. The teacher is then able to e-mail the graded work to the students' parents and/or print the graded work to return to the students.

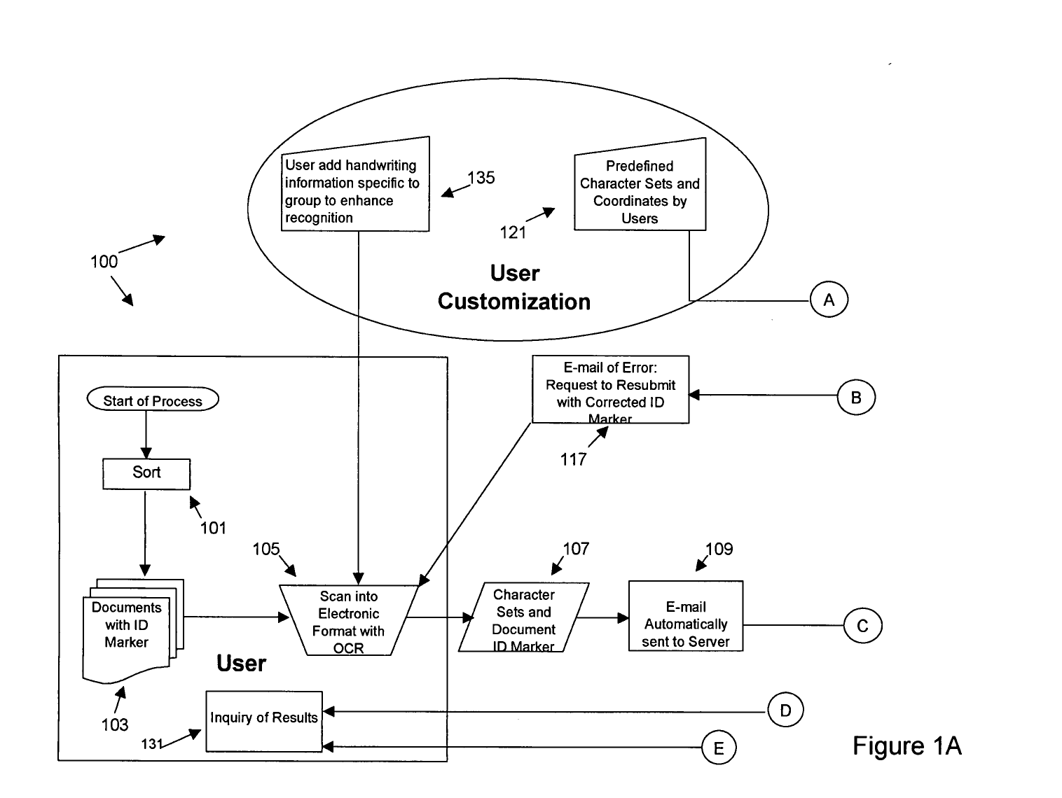

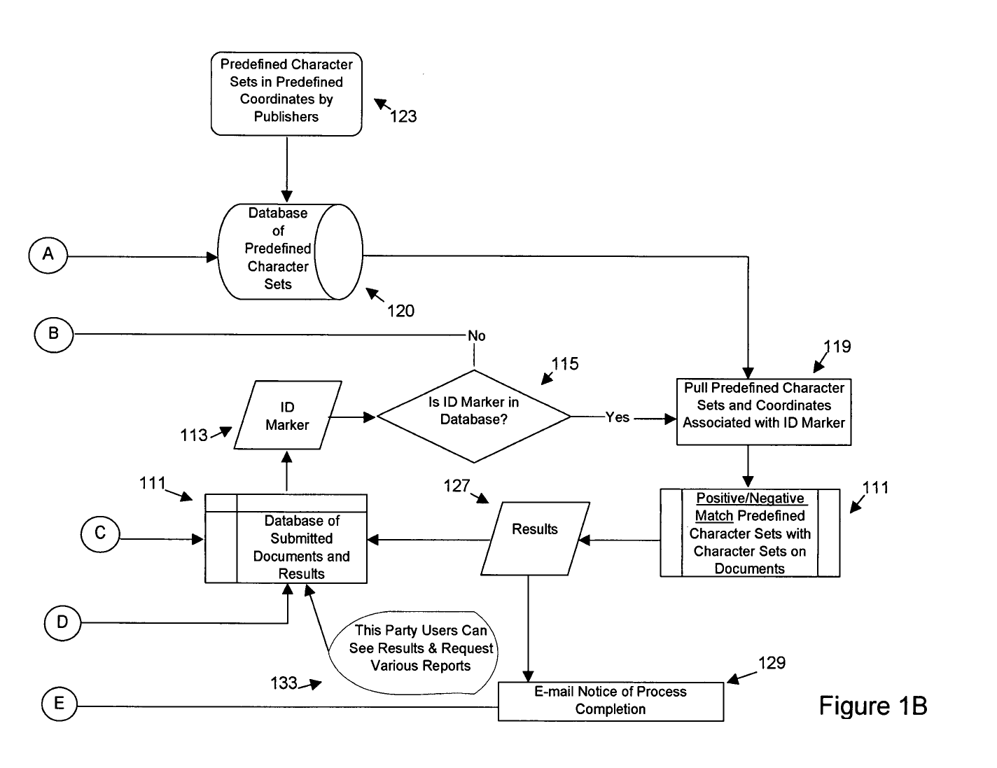

FIGS. 1a and 1b are a flowchart illustrating an exemplary process for using an automated grading system, in accordance with an embodiment of the present invention. Processes enacted by a user are encompassed within user areas l 00. In the present embodiment, a user wishing to use the automated grading system begins by collecting and sorting work to be graded in step 101. The user compiles a set of documents with an ID marker in step 103. In the present embodiment, each document will have a place for three fields. A field to identify the teacher, the student or user, and a form id number field. Assignments that are coming directly from a publisher may have the form id numbers pre-loaded. The system is able to process multiple formats of documents such as, but not limited to, handwritten, PDF, Excel and Word documents. In step 105 the user scans the documents from step 103 into a computer with OCR software to convert the documents into an electronic format. In the preferred embodiment, the OCR software converts the documents into ASCII text; however, alternate embodiments may use various common electronic formats such as, but not limited to, XML, HTML, PDF, GIF, JPEG. In the present embodiment, the information in the electronic format is converted into character sets with document ID markers in step 107.

In step 109 the system automatically sends an e-mail comprising the character sets and ID markers to a system server. In alternate embodiments this email may not be sent automatically. In these alternate embodiments the user sends the email comprising the character sets and ID markers. In the present embodiment, the server stores the character sets and ID markers in a documents and results database within the server in step 111. Then, in step 113 the system retrieves the ID marker of the work being graded from the documents and results database. In step 115 the system determines if the ID marker matches an ID marker stored in a character set database 120. If the ID marker is not in character set database 120, the system sends an error email to the user in step 117, requesting the user to resubmit the character set with a corrected ID marker, and the user must rescan the corrected document in step 105. If the ID marker is in character set database 120, the predefined character sets and coordinates associated with the ID marker are pulled from character set database 120 in step 119.

Predefined character sets may be loaded into character set database 120 from various sources. In the present embodiment, the user may input predefined character sets and coordinates into character set database 120 in step 121, or a publisher or other third party may input predefined character sets and coordinates into character set database 120 in step 123. For example, without limitation, publishers may wish to preload worksheets into the system that coincide with various lesson plans included in their books. If a worksheet is preloaded from a publisher of a text in step 123, the answers for the worksheet are automatically in the system in the form of a predefined character set corresponding to an ID marker on the worksheet. If the user is grading a publisher provided worksheet using the present embodiment, the user prints a cover sheet that corresponds to that particular worksheet and scans this coversheet along with the documents in step 105 in order for the system to access the character set and grade the worksheet. If the user is using a worksheet that he or she created, the user must create an answer template and input this answer template as a character set into character set database 120 in step 121.

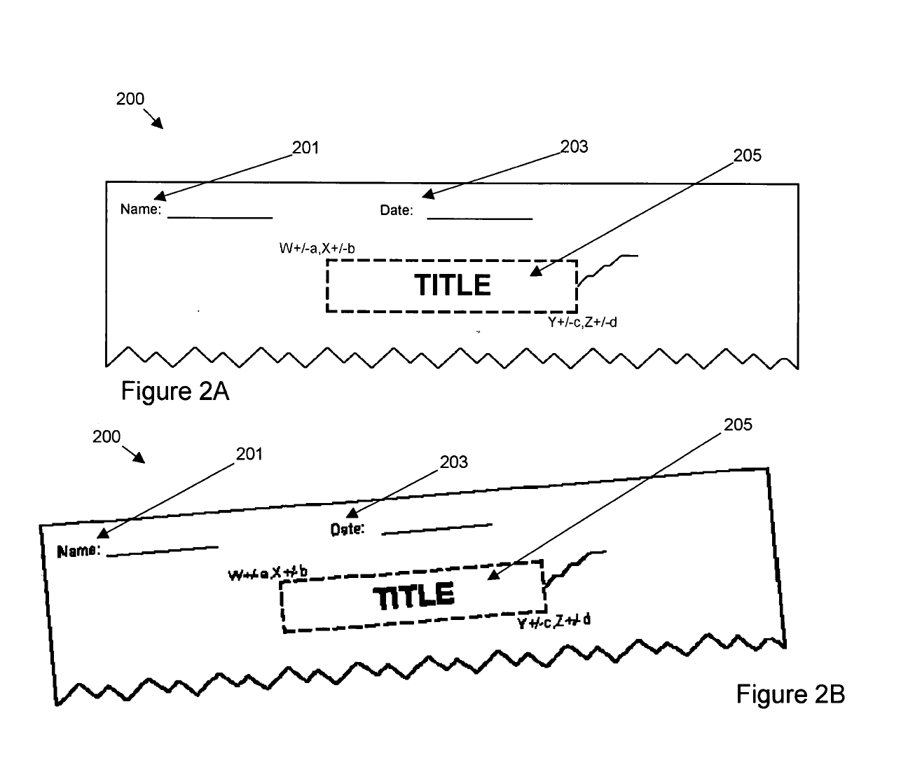

In the present embodiment, to create and input the answer template, the user first creates a cover sheet using the system. The user then scans the following pages in the following order: cover sheet, a blank worksheet, a filled out worksheet with the correct answers, and a blank page. The cover sheet instructs the system to create a new template for a homework assignment. The blank worksheet informs the system of what the preprinted material comprises, and the system uses the blank worksheet as a template for distortion correction, described by way of example in accordance with FIGS. 2a and 2b. The system then reads the filled out worksheet, recognizes the handwritten information as the answers, and develops an answer key character set. The blank sheet indicates to the system that no further answer sheets remain and the character set is loaded into character set database 120. In alternate embodiments, various other methods may be used to load character sets into a system database, for example, without limitation, various different sheets may be scanned in different orders or a blank worksheet may include instructions to create a new template and an ID marker so that a cover sheet is not required. In an alternative embodiment of the present invention, the teacher logs into the web interface and generate a worksheet directly from our website. Once this is done all of the information needed will already be in the system. additionally, if the homework assignment is from a publisher, the teacher will only need to select the homework assignment desired and print it out because all the grading information will be pre-loaded from the publisher.

In the present embodiment, once the predefined character set is retrieved from character set database 120 in step 119, the system compares this answer key character set to the character sets from the work being graded and checks off any data that does not match the answer key character set using data matching software in step 125. Once the system has corrected the work, the graded work is compiled as a set of results in step 127, and these results are stored in the documents and results database in step 111. In the present embodiment, the user receives an e-mail that the work is graded in step 129.

The user can then make an inquiry of the results from the documents and results database in step 131 if desired. Once the user receives the results from the documents and results database, the user may open the assignment and choose to be directed to all the incorrect answers. This enables the user to verify that the system did not incorrectly mark anything wrong. In some embodiments, once the user has verified the accuracy of the grading, the system may e-mail the parents a copy of the homework along with the graded results. Furthermore, in some embodiments, parents and teachers may have the option to have the system fill in the correct answer when an answer is graded as wrong. In some embodiments the parent can select an incorrectly marked answer and submit it for review to the teacher. In the present embodiment, third parties may also access the results and various reports from the documents and results database in step 133. In the present embodiment, the system is able to generate various reports in real-time to various parties including, without limitation, administrators, teachers, and parents. For example, without limitation, a school district may input demographic information about each student and generate reports accordingly. In other embodiments parents can login and look at their students progress on a day to day basis, providing virtual progress reports and digital images of their child's grades homework. In other embodiments the system can email the parent when the student has homework assigned. In other embodiments the parent can generate a query and receive homework help for their child.

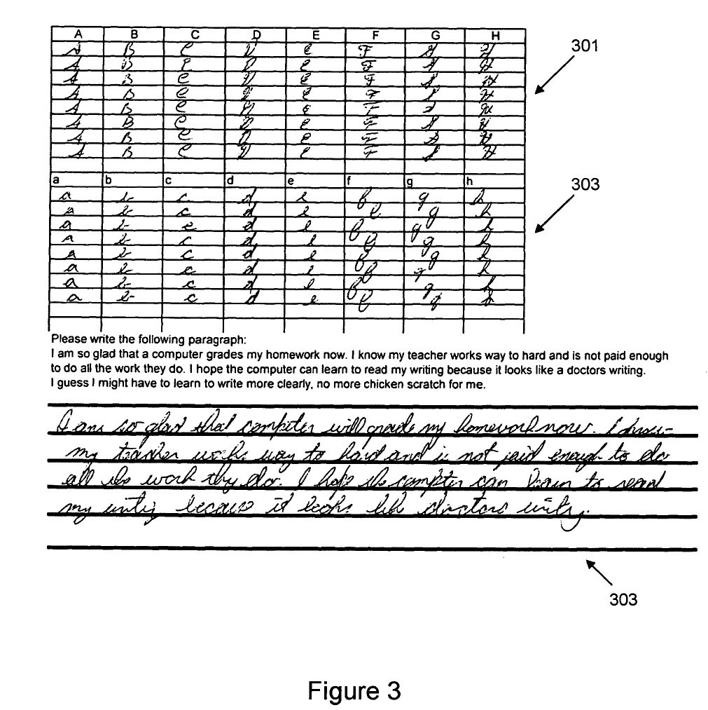

In the present embodiment, the user has the option to have students fill out a handwriting profile sheet, on which the student writes a writing sample, for example, without limitation, every letter in the alphabet and every number from 1 to 10. The student may also be required to copy a short story in handwritten format so that the software can more easily recognize that particular students' handwriting. A handwriting profile sheet is illustrated by way of example in FIG. 3. In step 135 the user gathers this handwriting profile information, and, the user scans the handwriting profile sheets into electronic formats with OCR software in step 105. The handwriting profiles are then converted into character sets with ID markers in step 107 and emailed to the system server in step 109. In the present embodiment the handwriting profiles will be loaded and saved to each students profile so as to improve the grading accuracy for each student. This data will also be added to the ocr software database to increase its ability to recognize a wider variety of handwritten characters. Alternate embodiments may not enable users to load handwriting information into the system server. For example, without limitation, embodiments implemented to grade mainly math assignments or typed assignments may not require handwriting information as numbers and typed work are generally less likely to be unrecognizable by the OCR software.

FIGS. 2a and 2b illustrate an exemplary form 200 as scanned using distortion correction, in accordance with an embodiment of the present invention. FIG. 2a illustrates the form with no distortion, and FIG. 2b illustrates the form with some distortion. The present embodiment varies from the prior art in how the system handles distortion correction, or making sure that the pages are lined up appropriately so that the software can grade the information on the papers. The distortion correction in the present embodiment utilizes the OCR technology to recognize certain words or characters on the answer sheet and adjusts where the software looks to find the written answers. For example, without limitation, the software may look for fields labeled name, date, assignment number, etc. Typically, name and date fields are at the top of the page, for example, without limitation, name field 201 and date field 203, while assignment number or assignment name fields are typically at the bottom of the page. In the present embodiment, the OCR software is set to recognize a title field 205. The software scans for the words in title field 205 on the answer template. Then the software scans for the same words on the students answer sheets, and aligns its search for answer data by adjusting search coordinates accordingly. For example, without limitation, in FIG. 2a title field 205 is located within the coordinates W,X and Y,Z, and in FIG. 2b, since form 200 is not properly aligned, title field 205 is located within the coordinates W+a, X+b and Y+c, Z+d; where a,b,c,d reference the movement from the standard placement of the form. It should be understood that this is not necessarily the exact formula that will be used in any given application to make this distortion correction work. This formula is presented as a conceptual tool to convey the general concept and those skilled in the art will readily recognize, in light of the present invention, how to adapt such a formula to achieve the desired outcome for any particular application.) Once the software recognizes the new coordinates for form 200 in FIG. 2b, these new coordinates are used to adjust where the software locates the answer fields. If the distortion is determined to invalidate any answer fields, an error message is sent to the user.

FIG. 3 illustrates an exemplary handwriting profile sheet, in accordance with an embodiment of the present invention. In the present embodiment, a student writes each letter multiple times in an upper case letter section 301 and a lower case letter section 303. The student also copies a paragraph in a writing sample section 305. Once a student fills out a handwriting profile sheet, the sheet is scanned and converted into an electronic form by the OCR software and sent to a system server where the data matching software can access the information. The handwriting profile sheet enables the system to recognize the handwriting of individual students. This may be particularly helpful for students who have poor handwriting. Those skilled in the art, in light of the present teachings, will recognize that handwriting profile sheets may have many different layouts and comprise various types of information. For example, without limitation, some handwriting profile sheets may comprise writing samples for the numbers 0 through 9, and some profile sheets may be for printed handwriting while other profile sheets may be for cursive writing.

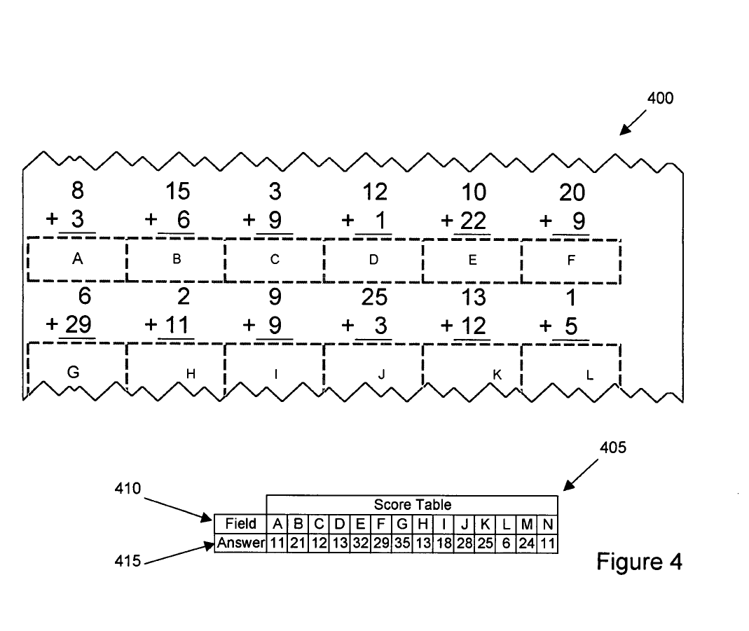

FIGS. 4 through 7 illustrate exemplary work to be graded and score tables using various types of comparisons for grading, in accordance with embodiments of the present invention. In the present embodiment, [the answer tables would be manually entered on the website once the assignment has been loaded. the phrase “answer tables” are meant to refer to how each question will be weighted for grading purposes. In the preferred embodiment there are default settings that the teacher can customize. for example, without limitation, each answer is always worth 1 point unless the user changes that manually. In this way the teacher can change the point value for each question only when needed. FIG. 4 illustrates a portion of an exemplary worksheet 400 that is graded using one verses one comparison and an exemplary corresponding score table 405, in accordance with an embodiment of the present invention. Score tables are used by the data matching software in preferred embodiments of the present invention to indicate what answers belong in what answer fields. In the present embodiment, score table 405 comprises a field row 410 and an answer row 415. Field row 410 comprises columns A through N corresponding to answer fields A through N on worksheet 400. In a one verses one comparison, there is only one acceptable answer for each question. Therefore, in score table 405 there is only one answer in answer row 415 corresponding to each field A through N.

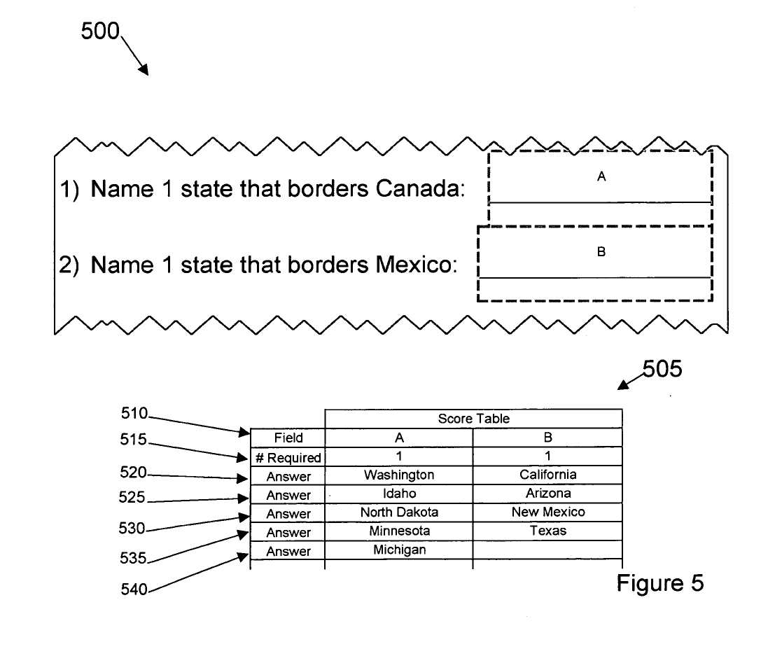

FIG. 5 illustrates a portion of an exemplary worksheet 500 that is graded using one verses many comparison and an exemplary corresponding score table 505, in accordance with an embodiment of the present invention. In the present embodiment, score table 505 comprises a field row 510, a number required row 515, and multiple answer rows 520, 525, 530, 535, and 540. Field row 510 comprises columns A and B corresponding to answer fields A and B on worksheet 500. Number required row 515 indicates to the software how many answers are required in the corresponding answer field. Since the present example is a one verses many comparison, one answer from many possible answers is required for each answer field. Answer rows 520, 525, 530, 535, and 540 list the possible answers for each answer field. For a non-limiting mathematical example of a one verses many comparison, if a teacher wants a student to explain 1+1+1=3 as a multiplication problem, either 3×1 or 1×3 is acceptable.

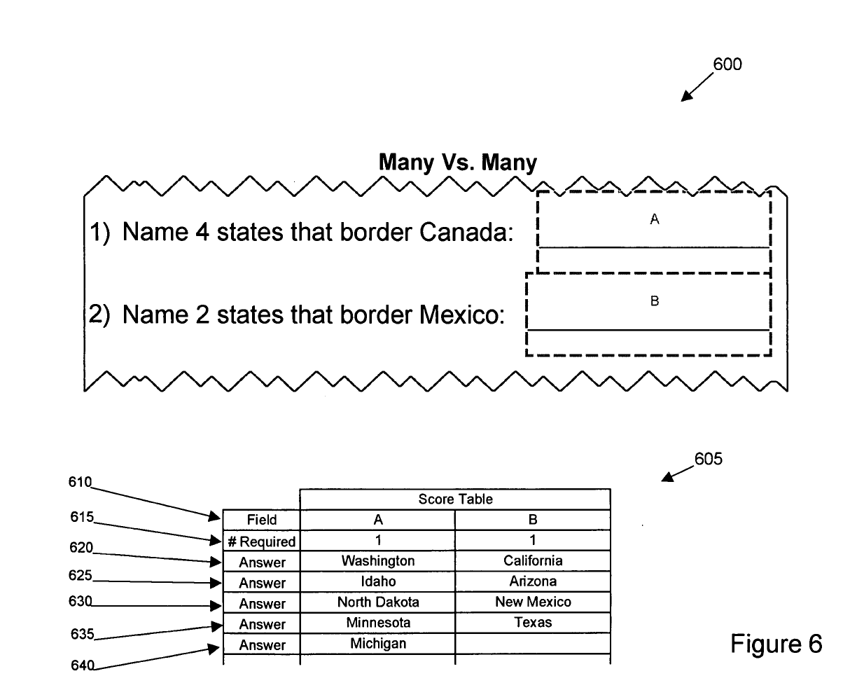

FIG. 6 illustrates a portion of an exemplary worksheet 600 that is graded using many verses many comparison and an exemplary corresponding score table 605, in accordance with an embodiment of the present invention. In the present embodiment, score table 605 comprises a filed row 610, a number required row 615, and multiple answer rows 620, 625, 630, 635, and 640. Field row 610 comprises columns A and B corresponding to answer fields A and B on worksheet 600. Number required row 615 indicates to the system how many answers are required in the corresponding answer field. Since the present example is a many verses many comparison, multiple answers from multiple possible answers are required in the answer fields. For example, without limitation, if a teacher wishes to allow multiple spellings for any given word in a many verses many dataset, the acceptable variations for that particular word are loaded into the software. In the present embodiment, four answers are required for answer field A and two answers are required for answer field B. Answer rows 620, 625, 630, 635, and 640 list the possible answers for each answer field.

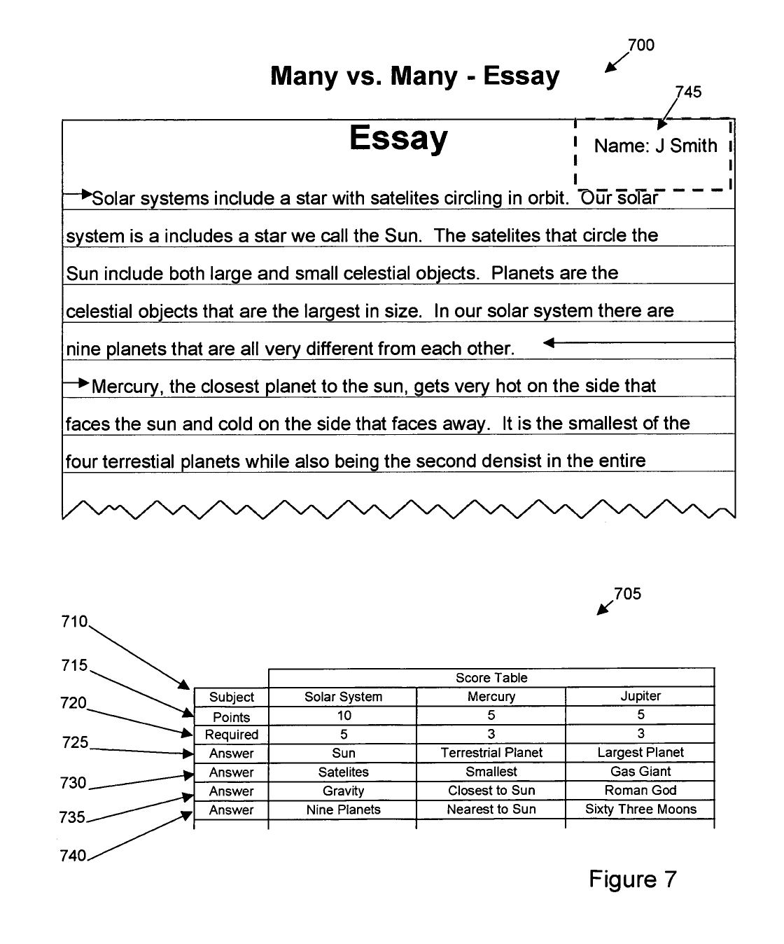

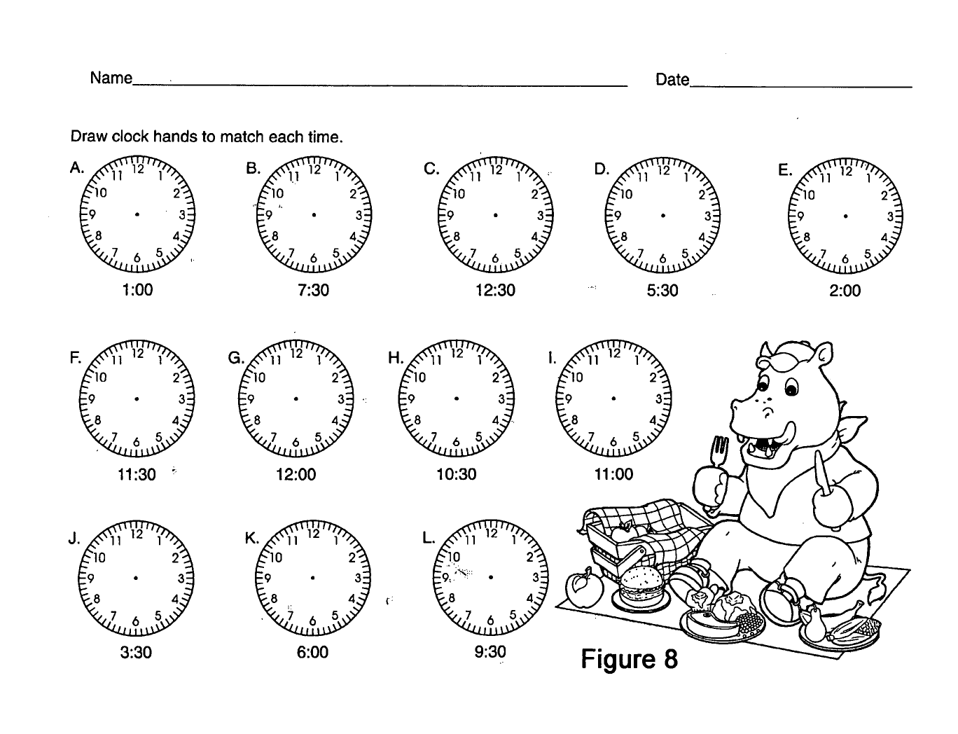

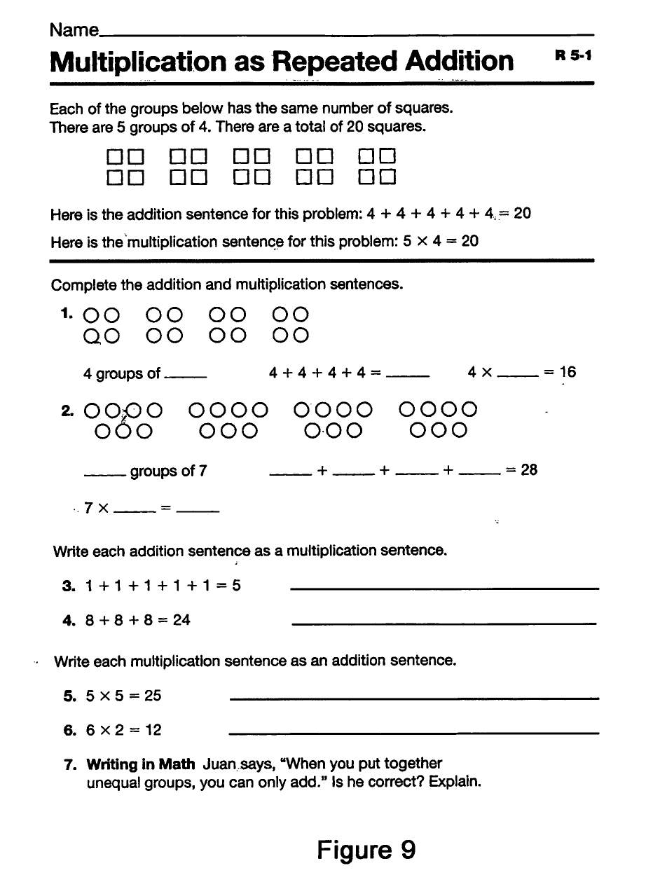

FIG. 7 illustrates a portion of an exemplary essay 700 that is graded using many verses many comparison and an exemplary corresponding score table 705, in accordance with an embodiment of the present invention. In the case of a multiple word answer, or an essay, teachers generally look for key words as well as grammar and punctuation errors. In the present embodiment, score table 705 comprises a subject row 710, a points row 715, a required row 720, and multiple answer rows 725, 730, 735, and 740. Subject row 710 comprises three columns corresponding to different possible subjects for each paragraph 700, a solar system column, a Mercury column and a Jupiter column. Points row 715 indicates the total points possible for the different subjects, and required row 720 indicates how many answers are required to achieve the total possible points. Answer rows 725, 730, 735, and 740 indicate to the software the key words that the teacher is looking for in the essay answer. Each subject column has its own set of key words. The software can then assign a grade value for how many of those key words the student has in their essay. For example, without limitation, if there are a total of 10 key words the teacher is looking for, and a student has eight of those ten key words, the student would get an 80%, barring any spelling or grammatical errors. This mimics the manual use of a rubric. Some embodiments of the present invention may also comprise spelling and grammar checking software along with the data matching software for grading written work such as, but not limited to, essays, reports, etc. FIGS. 8 and 9 illustrate exemplary free form homework assignments that may be graded by preferred embodiments of the present invention. FIG. 8 is an exemplary worksheet on reading clocks, and FIG. 9 is an exemplary worksheet on multiplication as repeated addition.

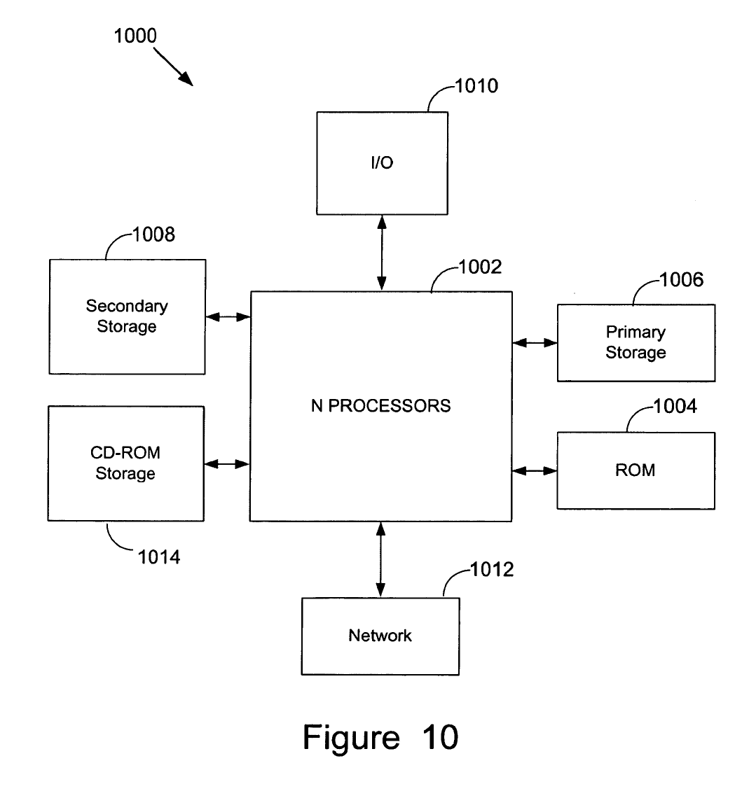

FIG. 10 illustrates a typical computer system that, when appropriately configured or designed, can serve as a computer system in which the invention may be embodied. The computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). CPU 1002 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 1004 acts to transfer data and instructions uni-directionally to the CPU and primary storage 1006 is used typically to transfer data and instructions in a bi-directional manner. Both of these primary storage devices may include any suitable computer-readable media such as those described above. A mass storage device 1008 may also be coupled bi-directionally to CPU 1002 and provides additional data storage capacity and may include any of the computer-readable media described above. Mass storage device 1008 may be used to store programs, data and the like and is typically a secondary storage medium such as a hard disk. It will be appreciated that the information retained within the mass storage device 1008, may, in appropriate cases, be incorporated in standard fashion as part of primary storage 1006 as virtual memory. A specific mass storage device such as a CD-ROM 1014 may also pass data uni-directionally to the CPU.

CPU 1002 may also be coupled to an interface 1010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionally may be coupled to an external device such as a database or a computer or telecommunications or internet network using an external connection as shown generally at 1012, which may be implemented as a hardwired or wireless communications link using suitable conventional technologies. With such a connection, it is contemplated that the CPU might receive information from the network, or might output information to the network in the course of performing the method steps described in the teachings of the present invention.

In the present embodiment, the subjects written about in the portion of essay 700 shown are the solar system and Mercury so the system uses the columns under solar system and Mercury in subject row 710. Essay 700 contains key words satellites, sun and nine planets from the solar system column and key words closest to sun, smallest and terrestrial planet from the Mercury column. The score for essay 700 under the solar system subject is six points since three out of five required key words are represented, which is sixty percent of the ten possible points. The score for essay 700 under the Mercury subject is five points since three out of three required key words are represented, or one hundred percent, and there is a total of five possible points for this subject. If there are no spelling or grammatical errors in essay 700, the total score for this portion of essay 700 is eleven points. This grading method may be used by the system to grade written work other than essays such as, but not limited to, questions requiring answers using full sentences, reports, etc.

A name field 745 on essay 700 enables the system to identify the student who wrote essay 700. This information may be used differently depending on the particular embodiment of the present invention. For example, without limitation, in some embodiments this information may be used for identification purposes only. In other embodiments the information may be used to create reports. In yet other embodiments that use handwriting profiles for students, the system may use this information to retrieve a handwriting profile for the student so that the handwriting can be more easily recognized. it should be noted that in the present embodiment the OCR will be able to recognize a substantial amount of hand writing on its own. Hence, the profiles are contemplated to mainly enhance the accuracy of the OCR for each student.

Preferred embodiments of the present invention enable teachers to create and grade free form homework assignments, not just template driven assignments. FIGS. 8 and 9 illustrate exemplary free form homework assignments that may be graded by preferred embodiments of the present invention. FIG. 8 is an exemplary worksheet on reading clocks, and FIG. 9 is an exemplary worksheet on multiplication as repeated addition. In the current context, free form means that the form is not restricted to a certain layout, or template. Templates often have a separate answer sheet and the answers need exact placement. These figures represent free form in that the questions and answers can be anywhere on the sheet, and do not require specific placement. In addition, FIG. 8 demonstrates the ability the software will have to recognize angles and shapes, which is not possible in conventional techniques.

Those skilled in the art, in light of the present teachings, will recognize that various embodiments may comprise various different features depending on the specific implementation of the system and the software. For example, without limitation, some embodiments may comprise tools for lesson plans and assignment scheduling. Using these embodiments, teachers can prepare lesson plans for several weeks or months ahead within the software. Then, if a teacher leaves for vacation or is sick, a substitute teacher can merely login under a user ID and password for the usual teacher and know exactly what lesson plans are to be taught, what is to be covered and what is to be assigned. In preferred embodiments, all data travels over the internet and is processed on servers within the system. However, some embodiments may enable users to set up their own servers to process some of the data. For example, without limitation, a school using an embodiment of the present invention may set up a local server to store results and create reports for the students attending that school throughout the years enabling the school to perform various tasks such as, but not limited to, tracking the progress of individual students or groups of students, tracking the performance of the school as a whole from year to year, etc. Some embodiments may also have various other features for teachers such as, but not limited to, grading options, record keeping options, etc. For example, without limitation, the software may enable teachers to assign a point value for each question so that worksheets and tests can be weighted. The software may enable teachers to break the various homework and class work assignments into categories such as, but not limited to, English, Science History, Math, etc. In some embodiments, the teacher has the option to select whether or not the assignment counts towards the student's grade or not. In some cases homework is not counted against the student's grade. This may also apply for extra credit assignments. In some embodiments, student scores are exportable into various file formats so that the teachers can upload the scores into an electronic “grade book”. Some embodiments may also enable school administrators to access real time reporting on all data gathered by the software. In some embodiments the system may comprise a reference section for teachers where teachers can input various ideas about how to teach certain subjects and different classroom activities from all over the country. Different searches within the reference section may be categorized by grade and topic. Some embodiments enable targeted advertising to be sold within the online application used by teachers, parents, and administrators to access information.

Some embodiments may also comprise features for parents. For example, without limitation, some embodiments may enable parents to login to a website to view their child's profile and view digital images of the child's homework online, as well as a virtual progress report and tips on how to help their children learn the materials being studied. The software can also provide teacher tips to parents to make learning more fun and interactive. Parents may also view what the students will be learning in the following weeks, along with being able to download homework helpers so that the parents can help their children with the homework. A non-limiting example is a parent who has forgotten how to do algebra or geometry. This parent could download a help sheet from a website connected to the system in order to help them coach their child through their homework. In some embodiments that provide digital images of the graded homework if the parent sees an error with the grading, the parent can select the incorrectly marked answer and submit it for review to the teacher. In some embodiments, the software can also deliver e-mails, if desired, to the student's parents with a copy of the homework attached. Furthermore, some embodiments may enable the student to do the homework online or upload their homework to the system themselves.

The embodiments described above are directed towards systems implemented to assist teachers in grading schoolwork. However, alternate embodiments of the present invention may be used in various different applications, for example, without limitation, in law enforcement. Currently, when an inmate receives a letter, a corrections officer reads the letter and looks for key words or combinations of words that would be considered violations. Software according to an embodiment of the present invention would enable law enforcement officials to program a predetermined set of words or combination of words to look for within inmate communications. Letters may then be scanned in and uploaded to servers within the system. The software looks for matches to key words within the letters to determine whether or not there are violations contained in the letters. These violations may then be reported to the officers for review. Other exemplary applications for embodiments of the present invention include without limitation, searches within databases that search for key words in the data stored in the database.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, without limitation, the servers and databases that receive and store information such as, but not limited to documents, character sets, ID markers, and results and the processes performed by the system server such as, but not limited to, the grading process may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing automated grading systems according to the present invention will be apparent to those skilled in the art. The invention has been described above by way of illustration, and the specific embodiments disclosed are not intended to limit the invention to the particular forms disclosed. For example, the particular implementation of the servers may vary depending upon the particular type of network used. The embodiments described in the foregoing were directed to Internet based implementations; however, similar techniques are to operate the system on a local network. Non-Internet based implementations of the present invention are contemplated as within the scope of the present invention. The invention is thus to cover all modifications, equivalents, and alternatives falling within the spirit and scope of the following claims.

What is claimed is:

1. A method for automated evaluation of documents, the method comprising steps of:
scanning a set of documents with Optical Character Recognition (OCR) software to produce an electronic format;
converting said electronic format into a character set associated with an ID marker;
storing said character set and ID marker in a first database;
retrieving a predefined character set corresponding to said ID marker from a second database;
identifying an identification field and predefined coordinates of said identification field in said predefined character set;
locating said identification field and character set coordinates of said identification field in said character set;
generating search coordinates from said predefined coordinates and said character set coordinates;
comparing at least a portion of said character set to at least a portion of said predefined character set using said search coordinates;
compiling a results set from results of said comparing;
storing said results set in said second database; and
generating a notification that said step of comparing is complete and said results set can be queried.

2. The method as recited in claim 1, wherein said step of comparing further comprises comparing said portion of said character set to a plurality of portions of said predefined character set.

3. The method as recited in claim 1, wherein said step of comparing further comprises comparing a plurality of portions of said character set to a plurality of portions of said predefined character set.

4. The method as recited in claim 1, further comprising the step of storing a worksheet character set and ID marker from a publisher as said predefined character set and ID marker in said second database.

5. The method as recited in claim 1, further comprising the steps of:
scanning a worksheet with OCR software to produce a worksheet electronic format;
converting said worksheet electronic format into a worksheet character set associated with an ID marker; and
storing said worksheet character set and ID marker as said predefined character set in said second database.

6. The method as recited in claim 1, further comprising the step of grading results of said comparing.

7. The method as recited in claim 1, wherein said step of compiling said results further comprises including said portion of said predefined character set.

8. The method as recited in claim 1, further comprising the step of querying said first database by a first user to generate a report.

9. The method as recited in claim 8, further comprising sending a portion of said report from said first user to a second user.

10. The method as recited in claim 1, further comprising the step of notifying a user that a document is due to be completed.

11. The method as recited in claim 1, further comprising the step of submitting a handwriting profile sheet and said step of converting further uses said handwriting profile sheet to improve accuracy.

12. A method for automated evaluation of documents, the method comprising:
steps for scanning a set of documents;
steps for converting said scanning into a character set;
steps for storing said character set;
steps for retrieving a predefined character set;
steps for identifying an identification field and predefined coordinates of said identification field in said predefined character set;
steps for locating said identification field and character set coordinates of said identification field in said character set;
steps for generating search coordinates from said predefined coordinates and said character set coordinates;
steps for comparing at least a portion of said character set to at least a portion of said predefined character set using said search coordinates;
steps for compiling a results set from results of said comparing;
steps for storing said results set; and
steps for generating a notification that said step of comparing is complete and said results set can be queried.

13. The method as recited in claim 12, further comprising steps for storing said predefined character set.

14. The method as recited in claim 12, further comprising steps for grading results of said comparing.

15. The method as recited in claim 12, further comprising steps for querying said results set.

16. The method as recited in claim 12, further comprising the steps for submitting a handwriting profile sheet to improve accuracy.

17. A method for automated evaluation of documents, the method comprising steps of:
scanning a set of documents with Optical Character Recognition (OCR) software to produce an electronic format;
converting said electronic format into a character set associated with an ID marker;
sending said character set and ID marker to a server for the evaluation; and
receiving from said server a results set wherein said results set comprises the results of a comparison of at least a portion of said character set to at least a portion of a predefined character set using search coordinates where said search coordinates were in part determined by an identification of an identification field and predefined coordinates of said identification field in said predefined character set and character set coordinates of said identification field in said character set.

18. The method as recited in claim 17, wherein said step of receiving further comprises receiving in said results set a comparison of said portion of said character set to a plurality of portions of said predefined character set.

19. The method as recited in claim 17, wherein said step of receiving further comprises receiving in said results set a comparison of a plurality of portions of said character set to a plurality of portions of said predefined character set.

20. The method as recited in claim 17, further comprising the steps of:
scanning a worksheet with OCR software to produce a worksheet electronic format;
converting said worksheet electronic format into a worksheet character set associated with an ID marker; and
sending said worksheet character set and ID marker to said server as said predefined character set.

21. The method as recited in claim 17, wherein said step of receiving further comprises receiving the results of a grading of said comparison.

22. The method as recited in claim 17, wherein said step of receiving further comprises receiving said portion of said predefined character set in said results set.

23. The method as recited in claim 17, further comprising the step of querying said server by a first user to generate a report.

24. The method as recited in claim 23, further comprising the step of instructing said server to send a portion of said report to a second user.

25. The method as recited in claim 17, wherein said step of converting uses a handwriting profile sheet to improve accuracy.

26. A method for automated evaluation of documents, the method comprising:
steps for scanning a set of documents;
steps for converting said electronic format into a character set;
steps for sending said character set to a server for the evaluation; and
steps for receiving from said server a results set.

27. The method as recited in claim 26, further comprising steps for sending a worksheet character set to said server as said predefined character set.

28. The method as recited in claim 26, further comprising steps for querying said server.

29. A computer program product for automated evaluation of documents, the computer program product comprising:
computer code that scans a set of documents with Optical Character Recognition (OCR) software to produce an electronic format;
computer code that converts said electronic format into a character set associated with an ID marker;
computer code that stores said character set and ID marker in a first database;
computer code that retrieves a predefined character set corresponding to said ID marker from a second database;
computer code that identifies an identification field and predefined coordinates of said identification field in said predefined character set;
computer code that locates said identification field and character set coordinates of said identification field in said character set;
computer code that generates search coordinates from said predefined coordinates and said character set coordinates;
computer code that compares at least a portion of said character set to at least a portion of said predefined character set using said search coordinates;
computer code that compiles a results set from results of said comparing;
computer code that stores said results set in said second database;
computer code that generates a notification that said step of comparing is complete and said results set can be queried; and
a computer-readable medium that stores the computer code.

30. The computer program product as recited in claim 29, further comprising computer code that compares said portion of said character set to a plurality of portions of said predefined character set.

31. The computer program product as recited in claim 29, further comprising computer code that compares a plurality of portions of said character set to a plurality of portions of said predefined character set.

32. The computer program product as recited in claim 29, further comprising:
computer code that scans a worksheet with OCR software to produce a worksheet electronic format;
computer code that converts said worksheet electronic format into a worksheet character set associated with an ID marker; and
computer code that stores said worksheet character set and ID marker as said predefined character set in said second database.

33. The computer program product as recited in claim 29, further comprising computer code that grades results of said comparing.

34. The computer program product as recited in claim 29, further comprising computer code that when compiling said results further includes said portion of said predefined character set.

35. The computer program product as recited in claim 29, further comprising computer code that allows querying said first database by a first user to generate a report.

36. The computer program product as recited in claim 29, further comprising computer code that uses a handwriting profile sheet to improve accuracy when converting said electronic format.

37. A system for automated evaluation of documents, the system comprising:
means for scanning a set of documents;
means for converting said scanning into a character set;
means for storing said character set;
means for retrieving a predefined character set;
means for identifying an identification field and predefined coordinates of said identification field in said predefined character set;
means for locating said identification field and character set coordinates of said identification field in said character set;
means for generating search coordinates from said predefined coordinates and said character set coordinates;
means for comparing at least a portion of said character set to at least a portion of said predefined character set using said search coordinates;
means for compiling a results set from results of said comparing;
means for storing said results set; and
means for generating a notification that said comparing is complete and said results set can be queried.

38. The system as recited in claim 37, further comprising means for storing said predefined character.

39. The system as recited in claim 37, further comprising means for grading results of said comparing.

40. The system as recited in claim 37, further comprising means for querying said results set.

41. The system as recited in claim 37, further comprising means for notifying a user that a document is due to be completed.

42. The system as recited in claim 37, further comprising means for submitting a handwriting profile sheet to improve accuracy.
